(19) United States
(12) Patent Application Publication
(10) Pub. No.: US 2016/0167331 A1
(43) Pub. Date: Jun. 16, 2016

(54) IMPROVED REVERSIBLE ADHESIVES AND METHODS OF FORMING THE SAME

(71) Applicant: THE TRUSTEES OF THE UNIVERSITY OF PENNSYLVANIA, Philadelphia, PA (US)

(72) Inventors: Shu YANG, Blue Bell, PA (US); Yudi RAHMAWAN, Beji Timur Depok (ID); Kahp-Yang SHU (DECEASED), Seoul (KR)

(21) Appl. No.: 14/909,477

(22) PCT Filed: Aug. 1, 2014
(86) PCT No.: PCT/US14/49376

§ 371 Date: Feb. 2, 2016

Related U.S. Application Data
(60) Provisional application No. 61/861,608, filed on Aug. 2, 2013.

(51) Int. Cl. B32B 3/10; B32B 27/20; B29C 39/02; B32B 27/40

(52) U.S. Cl. CPC B32B 3/10; B32B 27/40; B32B 27/20; B29C 39/025; B32B 2250/02; B32B 2264/102; B29K 2105/0002

(57) ABSTRACT

Provided herein are adhesion systems comprising a first substrate at least a portion of the surface of which having an array of micropillars, at least a distal portion of said micropillars having a plurality of particles embedded therein, and a second substrate at least a portion of the surface of which having an array of micropillars, at least a distal portion of said micropillars having a plurality of particles embedded therein. Adhesive materials comprising a substrate at least a portion of the surface of which having an array of micropillars, at least a portion of said micropillars having a plurality of particles embedded therein, and methods of forming the same, are also disclosed.

### CROSS REFERENCE TO RELATED APPLICATIONS

This application claims priority to U.S. Provisional Application No. 61/861,608, filed Aug. 2, 2013, the disclosure of which is hereby incorporated by reference in its entirety.

### GOVERNMENT RIGHTS

The subject matter disclosed herein was made with government support under grant number DMR-1105208 awarded by the National Science Foundation (NSF) GOALI grant. The Government may have certain rights in the herein disclosed subject matter.

### FIELD OF THE INVENTION

The invention relates to improved reversible adhesives and methods of forming the same.

### BACKGROUND OF THE INVENTION

Adhesives have many important applications, including, but not limited to, use in packaging, medicine, textiles, household needs, and fasteners. The development of improved reversible adhesives is highly desirable. This invention is directed to these and other important needs.

### SUMMARY OF THE INVENTION

Provided herein are adhesion systems comprising a first substrate at least a portion of the surface of which having an array of micropillars, at least a distal portion of said micropillars having a plurality of particles embedded therein, and a second substrate at least a portion of the surface of which having an array of micropillars, at least a distal portion of said micropillars having a plurality of particles embedded therein.

Adhesive materials comprising a substrate at least a portion of the surface of which having an array of micropillars, at least a portion of said micropillars having a plurality of particles embedded therein are also disclosed herein.

Further provided are methods of forming adhesive materials comprising drop-casting a particle suspension over a mold, wherein the particle suspension contains a solvent and a plurality of particles, removing excess solvent from the mold, removing excess particles, filling the mold with one or more elastomers, polymerizing the elastomers, and removing the adhesive material from the mold.

### BRIEF DESCRIPTION OF THE DRAWINGS

The summary, as well as the following detailed description, is further understood when read in conjunction with the appended drawings. For the purpose of illustrating the disclosed systems, materials, and methods there are shown in the drawings exemplary embodiments; however, the disclosed systems, materials, and methods are not limited to the specific systems, materials, and methods disclosed. In the drawings:

FIG. 1 represents an exemplary schematic illustration of the fabrication procedure to create dual-scale micropillars embedded with silica particles.

FIG. 2, comprising FIGS. 2A-D, represents SEM images of exemplary micropillars (5 μm diameter) embedded with silica particles of different diameters. Pristine micropillars (FIG. 2A), and micropillars embedded with silica having a particle diameter of 100 nm (FIG. 2B), 500 nm (FIG. 2C) and 1 μm (FIG. 2D).

FIG. 3, comprising FIGS. 3A-D, represents fluorescence images showing the distribution of silica particles of variable sizes in exemplary PUA micropillars (5 μm diameter and aspect ratio 8). For visualization purpose, micropillars were broken from the substrate, and the silica particles were dyed with FITC. Pristine micropillars (FIG. 3A) and micropillars embedded with silica having a particle diameter of 100 nm (FIG. 3B), 500 nm (FIG. 3C) and 1 μm (FIG. 3D).

FIG. 4, comprising FIGS. 4A-D, represents an exemplary set-up of the shear adhesion strength measurement test. Demonstration of a standard sample (1×1 cm²) that can lift a load of 3 lbs (FIG. 4A). Schematic of interlocked micropillars (FIG. 4B). SEM images of the interlocked micropillars at two magnifications (FIG. 4C). Illustration of individual particle-embedded dual scale micropillar to explain the effect of particle protrusion on interlocking adhesion with interweaving state (FIG. 4D).

FIG. 5, comprising FIGS. 5A-C, depicts a measured shear adhesion strength of exemplary smooth and particle-embedded dual-scale micropillars (5 μm diameter) as a function of spacing ratio and aspect ratio in comparison with theoretical values based on interwoven cylinder model. Three different aspect ratios were used: 8 (FIG. 5A), 6 (FIG. 5B), and 4 (FIG. 5C).

FIG. 6, comprising FIGS. 6A-C, depicts the reversibility of exemplary silica embedded micropillars having an aspect ratio of 8 (FIG. 6A), 6 (FIG. 6B), and 4 (FIG. 6C).

### DETAILED DESCRIPTION OF ILLUSTRATIVE EMBODIMENTS

The disclosed systems, materials, and methods may be understood more readily by reference to the following detailed description taken in connection with the accompanying figures and examples, which form a part of this disclosure. It is to be understood that the disclosed systems, materials, and methods are not limited to the specific systems, materials, and methods described and/or shown herein, and that the terminology used herein is for the purpose of describing particular embodiments by way of example only and is not intended to be limiting of the claimed systems, materials, and methods. Also, as used in the specification including the appended claims, the singular forms “a,” “an,” and “the” include the plural, and reference to a particular numerical value includes at least that particular value, unless the context clearly dictates otherwise. When a range of values is expressed, another embodiment includes from the one particular value and/or to the other particular value. Similarly, when values are expressed as approximations, by use of the antecedent “about,” it will be understood that the particular value forms another embodiment.

It is to be appreciated that certain features of the disclosed systems, materials, and methods which are, for clarity, described herein in the context of separate embodiments, may also be provided in combination in a single embodiment. Conversely, various features of the disclosed systems, materials, and methods that are, for brevity, described in the context of a single embodiment, may also be provided separately or in any subcombination. Further, reference to values stated in ranges include each and every value within that range. All ranges are inclusive and combinable.

As used herein, the term “about” is meant to encompass variations of ±20% or less, variations of 10% or less, variations of ±5% or less, variations of ±1% or less, variations of ±0.5% or less, or variations of ±0.1% or less from the specified value.

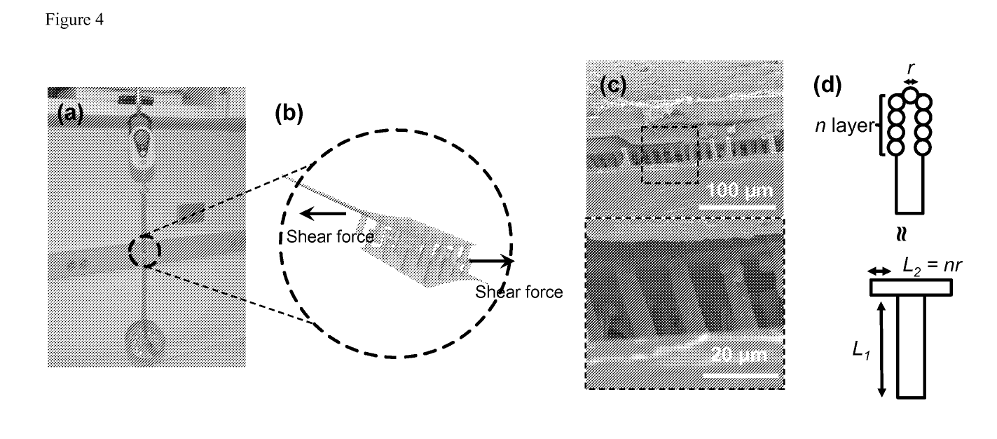

As used herein, the term “interdigitation” refers to pillars of two or more opposing pillar arrays coming into the inter-pillar space when brought into contact with or without the application of an external force. See, for example, FIG. 4A and 4B.

As used herein, the term “indentation state” refers to micropillars that are buckled and indented face to face with counter pillars after preloading.

As used herein, the term “preload” refers to an external pressure (force per unit area) applied either on one side or both sides of the engaged micropillars.

As used herein, the term “interweaving state” refers to micropillars that are buckled and entangled with and sliding against the counter buckled pillars.

As used herein, the term “pristine micropillars” refers to micropillars that are devoid of embedded particles.

As used herein, the term “aspect ratio” refers to the ratio of diameter of the micropillar to the height of the micropillar (diameter/height). Aspect ratio is abbreviated “AR” herein.

As used herein, the term “spacing ratio” refers to the ratio of the pillar-to-pillar distance to the diameter of the pillar (pillar-to-pillar distance/diameter). Spacing ratio is abbreviated “SR” herein.

As used herein, the term “elastomer” refers to a polymer having viscoelastic properties, and generally having a low Young's modulus and high failure strain compared with other materials.

As used herein, the term “distal end” refers to the end of the micropillar that is furthest from the support surface or substrate to which the micropillar is attached.

Disclosed herein are adhesion systems comprising a first substrate at least a portion of the surface of which having an array of micropillars, at least a distal portion of said micropillars having a plurality of particles embedded therein and a second substrate at least a portion of the surface of which having an array of micropillars, at least a distal portion of said micropillars having a plurality of particles embedded therein.

In some aspects of the systems, the micropillars can be attached to a support surface. In such aspects, the support surface is attached or connected to a substrate. The micropillars can be directly attached to the support surface. For example, the micropillars and support surface can be comprised of a single piece of material. Alternatively, the micropillars and support surface can be separate parts comprised of the same material which are directly connected. In other examples, the micropillars and support surface can be comprised of different materials which are directly connected.

In other aspects, the micropillars can be indirectly connected to a support surface. Indirect connection to a support surface can be achieved by several means, including, but not limited to, the use of linkers or materials that are separate and distinct from the micropillars themselves.

The support surface can include any geometric shape. In some aspects, the support surface can be linear. In other aspects, the support surface can be non-linear. Examples of non-linear support surfaces include, but are not limited to cylinders, rods, and other curved surfaces.

In some aspects, the micropillars are attached to the substrate without the use of a support surface. Thus, in some embodiments, the micropillars can be directly connected to the substrate. In other embodiments, the micropillars can be indirectly connected to the substrate.

The micropillars of the systems have a plurality of particles embedded on at least a portion of the distal end of the micropillar. Thus, for example, when the micropillars are connected to a support surface or substrate, at least of portion of the embedded particles are located at the end of the micropillars that is furthest away from the support surface. “Distal end,” “tip,” and “top” may be used interchangeably herein. As used herein, the term “embedded on” refers to particles being attached to the micropillar. In some embodiments, a portion of the particle can be inside the micropillar while the reminder of the particle is outside the micropillar. In other embodiments, the entire particle is located on the outside of the micropillar but attached to the surface.

In some aspects, the plurality of particles can be embedded substantially on a distal end of the micropillars. Thus, in some embodiments, the majority of particles can be embedded on the distal end of the micropillars. In other embodiments, all of the particles can be embedded on the distal end of the micropillars.

The plurality of particles can be embedded throughout said micropillars. For example, in some embodiments, the majority of the particles can be embedded along the lengths of the micropillars. In other embodiments, an equal amount of particles can be embedded along the lengths and distal end of the micropillars. In other embodiments, the plurality of particles can be embedded randomly on said micropillars.

Micropillars can be comprised of an elastomer. Thus, the micropillars can comprise any material having rubber-like properties. Suitable elastomers include, but are not limited to, silicones (e.g. poly(dimethylsiloxane)), acrylates (e.g. poly(n-butyl acrylate)), polyurethane, ethylene propylene diene rubber, propylene based elastomers, or any combination thereof. In some embodiments, the elastomer can be a polyurethane acrylate (PUA). In some embodiments, the PUA can be a soft PUA (i.e. PUA having a Young's modulus of about 19.8 MPa).

In some aspects of the systems, the plurality of particles can comprise a single particle type. In other aspects of the invention, the plurality of particles can comprise two or more particles types.

Numerous particles types are suitable for use in the disclosed systems. In some embodiments, the particle can be a polymeric particle. Polymeric particles include, but are not limited to, polystyrene, polymethyl methacrylate, silicone-based particles, or any combination thereof. Thus, for example, the plurality of particles can comprises silica. In other embodiments, the particle can be an inorganic particle. Inorganic particles include, but are not limited to, titania, ZnO, metallic particles, or any combination thereof.

The particles can have various diameters. Suitable diameters can be from about 500 nm to about 10 μm, from about 100 nm to about 5 μm, and from about 20 nm to about 1 μm. In some embodiments, the plurality of particles can have a diameter of from about 500 nm to about 10 μm. In some embodiments, the plurality of particles can have a diameter of from about 100 nm to about 5 μm. In some embodiments, the plurality of particles can have a diameter of from about 20 nm to about 1 μm. In some embodiments, the plurality of particles can have a diameter of from about 20 nm to about 10 μm. In some aspects, the particle diameter is between about 2% to about 20% of the diameter of the micropillar.

The micropillars can have various diameters. Suitable diameters can be from about 100 nm to about 50 μm, from about 50 nm to about 25 μm, and from about 25 nm to about 10 μm. In some embodiments, the micropillars can have a diameter of from about 100 nm to about 50 μm. In some embodiments, the micropillars can have a diameter of from about 50 nm to about 25 μm. In other embodiments, the micropillars can have a diameter of from about 25 nm to about 10 μm.

The micropillars can have various heights. Suitable heights can be between from about 1 μm to about 500 μm, from about 10 μm to about 250 μm, and from about 50 μm to about 100 μm. In some embodiments, the array of micropillars can have a height of from about 1 μm to about 500 μm. In some embodiments, the array of micropillars can have a height of from about 10 μm to about 250 μm. In some embodiments, the array of micropillars can have a height of from about 50 μm to about 100 μm.

The plurality of particles embedded at the distal end of the micropillars can have various thicknesses. In some embodiments, a single layer of particles can be embedded on the distal end of the micropillars, such that the thickness of the particles is equal to the diameter of the particle. In other embodiments, multiple layers of particles can be embedded on the distal end of the micropillars, such that the thickness of the particles is equal to the diameter of the particles multiple by the number of particle layers. The thickness of particles embedded at the distal end of the micropillars can range from about 1% to about 50% of the height of the micropillar. Thus, for example, when the micropillar has a height of 500 μm, the thickness of particles at the distal tip can be from about 5 μm to about 250 μm.

In some aspects, the array of micropillars is selected to conform to a geometric pattern. One of skill in the art would know that numerous geometric patterns exist. The array of micropillars can conform to numerous geometric patterns, including, but are not limited to, squares, rectangles, circles, ellipses, triangles, pentagons, hexagons, and the like.

In some embodiments, the array of micropillars are ordered such that there is an equal distance between each micropillar. In other embodiments, the array of micropillars can be not ordered, such that the distances between micropillars are not equal. In some aspects, the array of micropillars can be randomly spaced.

The aspect ratio (AR) of the micropillars is the ratio of micropillar diameter to micropillar height. Suitable ARs include from about 2 to about 10. In some embodiments, the array of micropillars can have an AR of about 2 to about 10. In some embodiments, the AR can be 2. In other embodiments, the AR can be 4. In other embodiments, the AR can be 6. In other embodiments, the AR can be 8. In other embodiments, the AR can be 10.

The spacing ratio (SR) of the micropillars is the ratio of the pillar-to-pillar distance to the diameter of the pillar (pillar-to-pillar distance/diameter). Suitable SRs include from about 2 to about 6. In some embodiments, the array of micropillars can have an SR of about 2 to about 6. In some embodiments, the SR can be 2. In other embodiments, the SR can be 4. In other embodiments, the SR can be 6.

The substrates can be arranged such that the array of micropillars from the first substrate are capable of interacting with the array of micropillars from the second substrate. In one example, the substrates can be arranged parallel to each other such that the micropillars from a first substrate interacts with the micropillars from a second substrate. In other examples, the substrates are not parallel, but are arranged in a manner such that the micropillars from a first substrate interact with the micropillars from a second substrate.

Micropillars from one substrate can interact with micropillars from a second substrate by any number of ways. For example, in some embodiments, the array of micropillars from the first substrate and the array of micropillars from the second substrate are capable of interlocking. Interlocking comprises interdigitation, interweaving, indentation, or any combination thereof. The type of interlocking is dependent on a variety of factors including pillar spacing and symmetry, pillar-pillar alignment, external load, bending of the lever arm of the pillars, or any combination thereof. When the preload is small, the pillars remain straight and can interdigitate with pillars from the other set of pillars when the SR is large, and the adhesion could be amplified by increasing the effective contact area.

In some aspects, the strength of interaction between the array of micropillars from the first substrate and the array of micropillars from the second substrate can be greater than an interaction between pristine micropillars (i.e. micropillars lacking embedded particles). In some embodiments, the strength of interaction can be at least four to five times greater than an interaction between pristine micropillars. In other embodiments, the strength of interaction can be an order of magnitude greater than an interaction between pristine micropillars.

In some aspects, the interaction between the micropillars from different substrates (i.e. micropillars from the first substrate and the micropillars of the second substrate) is reversible.

In some aspects, the adhesion system is reusable. Thus the adhesion system can be used numerous times before the adhesive strength begins to decrease. In some embodiments, the adhesion system can be reused twice. In other embodiments, the adhesion system can be reused three times. In other embodiments, the adhesion system can be reused four times. In other embodiments, the adhesion system can be reused five times. In yet other embodiments, the adhesion system can be reused more than five times.

In some aspects, the adhesion system optionally comprises one or more additional substrates at least a portion of the surface of which having an array of micropillars, at least a portion of said micropillars having a plurality of particles embedded therein. Thus, the adhesion system can comprise three or more substrates at least a portion of the surface of which have an array of micropillars, at least a portion of the micropillars having a plurality of particles embedded therein.

Also disclosed are adhesive materials comprising a substrate at least a portion of the surface of which having an array of micropillars, at least a portion of said micropillars having a plurality of particles embedded therein.

In some aspects of the adhesive materials, the micropillars can be attached to a support surface. In such aspects, the support surface is attached or connected to a substrate. The micropillars can be directly attached to the support surface. For example, the micropillars and support surface can be comprised of a single piece of material. Alternatively, the micropillars and support surface can be separate parts comprised of the same material which are directly connected. In other examples, the micropillars and support surface can be comprised of different materials which are directly connected. The micropillars can be indirectly connected to a support surface. Indirect connection to a support surface can be achieved by several means, including, but not limited to, the use of linkers or materials that are separate and distinct from the micropillars themselves.

The support surface can include any geometric shape. Thus, in some aspects, the support surface can be linear. In other aspects, the support surface can be non-linear. Examples of non-linear support surfaces include, but are not limited to cylinders, rods, and other curved surfaces.

In some aspects of the adhesive materials, the micropillars are attached to the substrate without the use of a support surface. Thus, in some embodiments, the micropillars can be directly connected to the substrate. In other embodiments, the micropillars can be indirectly connected to the substrate.

The micropillars of the adhesive materials have a plurality of particles embedded on at least a portion of the distal end of the micropillar. Thus, for example, when the micropillars are connected to a support surface or substrate, at least of portion of the embedded particles are located at the end of the micropillars that is furthest away from the support surface. In some embodiments, a portion of the particle can be inside the micropillar while the reminder of the particle is outside the micropillar. In other embodiments, the entire particle is located on the outside of the micropillar but attached to the surface.

The plurality of particles can be embedded substantially on a distal end of the micropillars that make up the adhesive materials. In some embodiments, the majority of particles can be embedded on the distal end of the micropillars. In other embodiments, all of the particles can be embedded on the distal end of the micropillars. Alternatively, the plurality of particles can be embedded throughout said micropillars. In some embodiments, for example, the majority of the particles can be embedded along the lengths of the micropillars. In other embodiments, an equal amount of particles can be embedded along the lengths and distal end of the micropillars. The plurality of particles can also be embedded randomly on said micropillars.

Micropillars can be comprised of an elastomer. Thus, the micropillars can comprise any material having rubber-like properties. Suitable elastomers include, but are not limited to, silicones (e.g. poly(dimethylsiloxane)), acrylates (e.g. poly(n-butyl acrylate)), polyurethane, ethylene propylene diene rubber, propylene based elastomers, or any combination thereof. In some embodiments, the elastomer can be a polyurethane acrylate (PUA). In some embodiments, the PUA can be a soft PUA (i.e. PUA having a Young's modulus of about 19.8 MPa).

In some aspects of the adhesive materials, the plurality of particles can comprise a single particle type. In other aspects of the invention, the plurality of particles can comprise two or more particles types.

In some embodiments, the plurality of particles can be a polymeric particle. Polymeric particles include, but are not limited to, polystyrene, polymethyl methacrylate, silicone-based particles, or any combination thereof. In some embodiments, for example, the plurality of particles can comprises silica. In other embodiments, the particle can be an inorganic particle. Inorganic particles include, but are not limited to, titania, ZnO, metallic particles, or any combination thereof.

The particles can have various diameters. Suitable diameters can be from about 500 nm to about 10 μm, from about 100 nm to about 5 μm, and from about 20 nm to about 1 μm. In some embodiments, the plurality of particles can have a diameter of about 500 nm to about 10 μm. In some embodiments, the plurality of particles can have a diameter of about 100 nm to about 5 μm. In some embodiments, the plurality of particles can have a diameter of about 20 nm to about 1 μm. In some embodiments, the plurality of particles can have a diameter of about 20 nm to about 10 μm. In some aspects, the particle diameter is between about 2% to about 20% of the diameter of the micropillar.

The micropillars can have various diameters. In some embodiments, the micropillars can have a diameter of from about 100 nm to about 50 μm. In some embodiments, the micropillars can have a diameter of from about 50 nm to about 25 μm. In other embodiments, the micropillars can have a diameter of from about 25 nm to about 10 μm.

The micropillars can have various heights. Suitable heights can be between from about 1 μm to about 500 μm, from about 10 μm to about 250 μm, and from about 50 μm to about 100 μm. In some embodiments, the array of micropillars can have a height of from about 1 μm to about 500 μm. In some embodiments, the array of micropillars can have a height of from about 10 μm to about 250 μm. In some embodiments, the array of micropillars can have a height of from about 50 μm to about 100 μm.

The plurality of particles embedded at the distal end of the micropillars can have various thicknesses. In some embodiments, a single layer of particles can be embedded on the distal end of the micropillars, such that the thickness of the particles is equal to the diameter of the particle. In other embodiments, multiple layers of particles can be embedded on the distal end of the micropillars, such that the thickness of the particles is equal to the diameter of the particles multiple by the number of particle layers. The thickness of particles embedded at the distal end of the micropillars can range from about 1% to about 50% of the height of the micropillar. Thus, for example, when the micropillar has a height of 500 μm, the thickness of particles at the distal tip can be from about 5 μm to about 250 μm.

In some aspects, the array of micropillars is selected to conform to a geometric pattern. One of skill in the art would know that numerous geometric patterns exist. The array of micropillars can conform to numerous geometric patterns, including, but are not limited to, squares, rectangles, circles, ellipses, triangles, pentagons, hexagons, and the like.

In some embodiments of the adhesive materials, the array of micropillars are ordered such that there is an equal distance between each micropillar. In other embodiments, the array of micropillars can be not ordered, such that the distances between micropillars are not equal.

The aspect ratio (AR) of the micropillars is the ratio of micropillar diameter to micropillar height. Suitable ARs include from about 2 to about 10. In some embodiments, the array of micropillars can have an AR of about 2 to about 10. In some embodiments, the AR can be 2. In other embodiments, the AR can be 4. In other embodiments, the AR can be 6. In other embodiments, the AR can be 8. In other embodiments, the AR can be 10.

The spacing ratio (SR) of the micropillars is the ratio of the pillar-to-pillar distance to the diameter of the pillar (pillar-to-pillar distance/diameter). Suitable SRs include from about 2 to about 6. In some embodiments, the array of micropillars can have an SR of about 2 to about 6. In some embodiments, the SR can be 2. In other embodiments, the SR can be 4. In other embodiments, the SR can be 6.

The array of micropillars can be configured to interact with micropillars from one or more substrates. In some embodiments, the array of micropillars from the adhesive material can interact with micropillars from a second adhesive material to form the adhesion systems disclosed herein. In some embodiments, for example, the adhesion system comprises two or more adhesive materials. The micropillars of different substrates can interact through, for example, interlocking, which includes interdigitation, interweaving, indentation, or any combination thereof.

Also disclosed are methods of forming adhesive materials comprising drop-casting a particle suspension over a mold, wherein the particle suspension contains a solvent and a plurality of particles, removing excess solvent from the mold, removing excess particles, filling the mold with one or more elastomers, polymerizing the elastomers, and removing the adhesive material from the mold.

In some aspects, the mold comprises polydimethylsiloxame (PDMS).

Numerous particles types are suitable for use in the method. In some embodiments, the particle can be a polymeric particle. Polymeric particles include, but are not limited to, polystyrene, polymethyl methacrylate, silicone-based particles, or any combination thereof. Thus, for example, the plurality of particles can comprises silica. In other embodiments, the particle can be an inorganic particle. Inorganic particles include, but are not limited to, titania, ZnO, metallic particles, or any combination thereof.

In some aspects, the excess solvent is removed by blading. Blading can be performed by an automated system or manually. The speed of blading can be controlled in order to control the evaporation time of the solvent. In one embodiment, for example, a blading speed of about 1 mm/s can be used for 1 wt % silica particle suspensions.

In some aspects of the method, the elastomer can be UV-curable PUA. Thus, for example, the elastomers can be polymerized by photopolymerization with UV light.

### EXAMPLES

Preparation of Nanopaticle Suspensions

Silica nanoparticles with diameter of 100 nm were provided by Nissan chemicals, Ltd. (Japan). Nanoparticles were harvested from isopropanol solution by centrifugation at 6000 rpm for 30 min using Eppendorf Centrifuge 5804R. Pelletized silica particles were separated from the solvent by overnight evaporation in an oven at 65° C. Silica particles with 500 nm and 1 μm particles were purchased from Alfa Aesar as powders. Silica particle suspensions were prepared by dissolving the particles in 1 wt % in ethyl alcohol (200 Proof, Decon Laboratories, Inc., United States). Suspensions were shaken in M16700 Barnstead Thermolyne (ThermoScientific, United States) for 15 minutes followed by mixing in ultrasonic mixer, Branson 2210 (Emerson Industrial Automation, United States) for 60 min at room temperature.

Fabrication of Nanoparticles-Embedded Micropillars

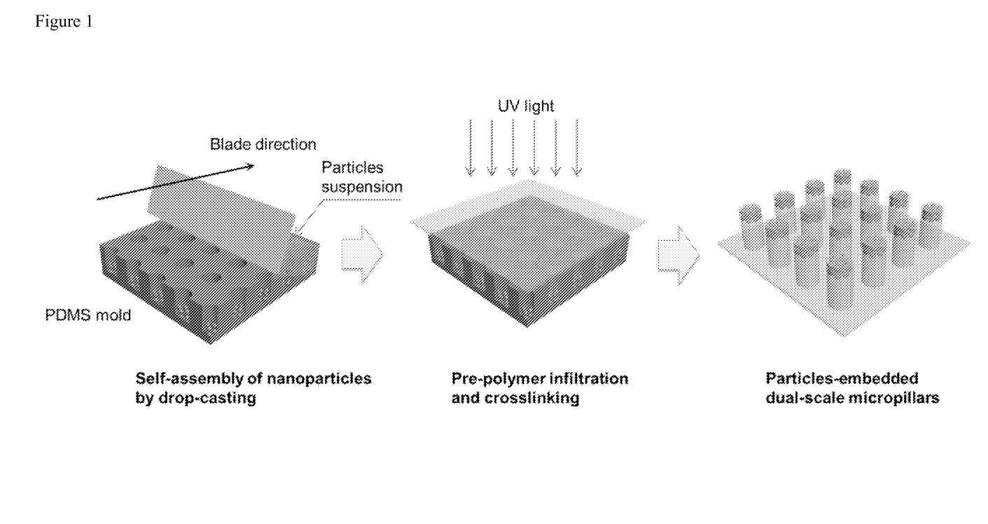

PUA micropillar arrays (5 μm diameter) of different ARs and SRs were fabricated by replica molding from the PDMS mold, prepared by mixing Sylgard 184 (Dow Corning) prepolymer and crosslinker (10:1 wt/wt), followed by degassing in vacuo for 1 h, and baking in an oven at 65° C. for 1 h. Silica particle suspension was drop-cast over the PDMS mold, followed by blading using a glass slide in one direction (FIG. 1). The speed of manual blading was controlled such that the evaporation of the solvent was not too fast over the sample area (˜10 s/cm²). Typically, a blading speed of about 1 mm/s was proper for 1 wt % silica particle suspensions. After the solvent was completely evaporated, the overflown silica particles on the mold surface were removed by 3M Scotch tape. Then, a UV-curable PUA prepolymer (Minuta Tech, Korea) was back-filled into the mold with a polyethylene terephthalate (PET) film (250 μm thick, McMaster & Carr, United States) as a supporting backplane. The PUA prepolymer with silica particles was photopolymerized in the mold by exposure to UV light (97436 Oriel Flood Exposure Source, Newport Corp., United States) at an intensity of 2000 J/cm², followed by peeling off the PDMS mold to obtain the nanoparticles-embedded dual-scale micropillars.

Preparation of FITC-Dyed Particles

Fluorescein isothiocyanate (FITC)-dyed particles were prepared as known in the art. (See, e.g., A. Vanblaaderen, A. Vrij, Langmuir 1992, 8, 2921). Briefly, an amino-functionalized (FITC-APS) dye was prepared by mixing 2 mL ethanol and 1.5 mg FITC (Sigma-Aldrich) and 0.24 mL 3-(aminopropyl) triethoxysilane (APS, Sigma-Aldrich) and stirred for 12 h at room temperature. FITC-functionalized particles were prepared by mixing 1 wt % silica particle suspension in ethanol (6.5 mL) with 551 μL NH₄OH, 48.15 μL tetraethyl orthosilicate (TEOS) and 20.8 μL FITC-APS for 48 h at room temperature.

Shear Adhesion Tests

The macroscopic shear adhesion force was measured by pulling interlocked pillars using a custom-built device. (See Y. Rahmawan, T. I. Kim, S. J. Kim, K. R. Lee, M. W. Moon, K. Y. Suh, Soft Matter 2012, 8, 1673). The shear adhesion force was translated into shear adhesion strength by taking the maximum/pull-off force per unit area after a preload (˜300 g) was applied by gently finger rubbing. A hanging scale with precision of ±5 g (American Weigh Scales, United States) was used to pull in parallel direction of the substrate with interlocked micropillars.

Characterization of Micropillars

The surface morphology was characterized by scanning electron microscope (SEM) using FEI 600 Quanta FEG environmental SEM. The samples were coated with 9 nm Au/Pd prior to observation. The fluorescent images of FITC-functionalized particles was observed using Olympus BX61 Motorized Microscope. First, the particles-embedded micropillars were inscribed using a razor blade, followed by dispersion in water and drop cast on a glass slide. After evaporation of water, the clusters of micropillars were imaged under the fluorescent mode.

Embedding particles in polymer micropillars

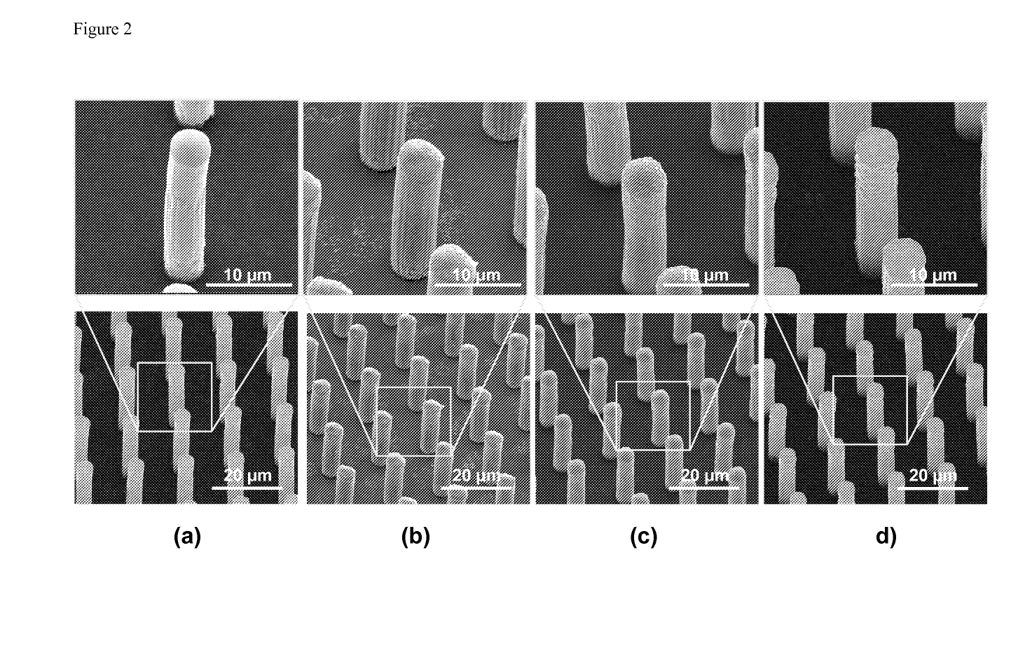

The particle-embedded dual-scale micropillar arrays were fabricated according to the procedure shown in FIG. 1. First, 1 wt % silica particle suspension in ethanol was drop-cast on the PDMS mold, followed by infiltration of PUA prepolymer and UV curing. To make a uniform distribution of particles in the tips of micropillars, the suspension drops were spread by a glass slide and bladed in one direction. Compared to the pristine micropillars with smooth surface (FIG. 2A), the silica particles were uniformly assembled on the top part of the pillars (FIG. 2B-D).

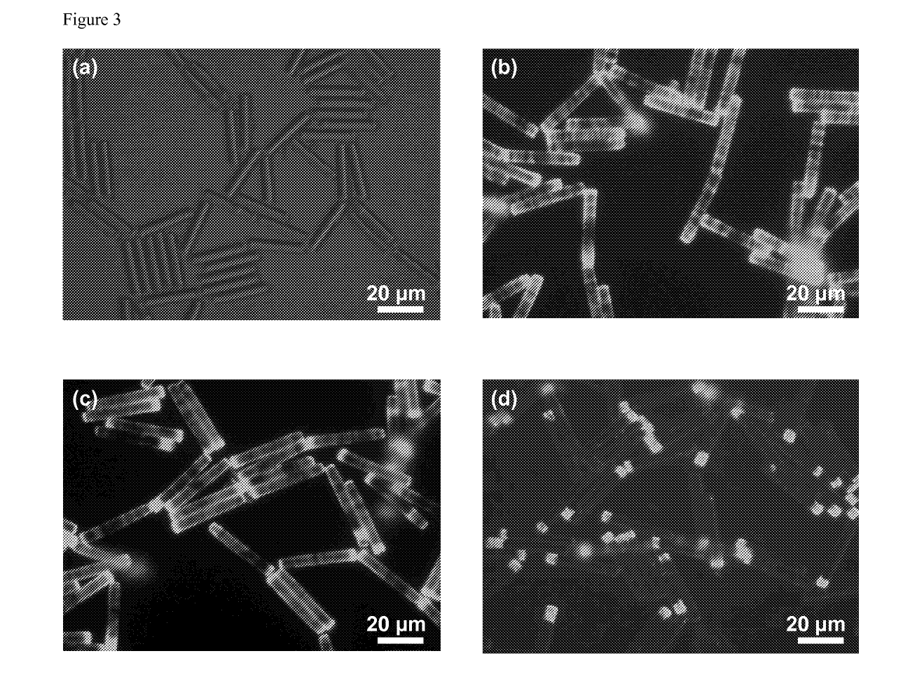

First, the distribution of particles on pillar heads was investigated as a function of particle size. As exemplified in FIG. 2, when the nanoparticle size was small (100 nm), a relatively random distribution of the nanoparticles was observed on the surface of micropillars. When the particle size was increased to 500 nm and 1 μm, the particles were nearly close-packed. To further examine the distribution of particles within the whole micropillars, the particles were labeled using FITC dye. Fluorescent images in FIG. 3 showed that the distribution of particles was highly dependent on particle sizes. Consistent with the SEM images, pristine PUA micropillars showed smooth pillars surface with little fluorescence (FIG. 3A). The pillars embedded with 100 nm FITC-silica particles were found with particles randomly assembled over the entire surface of the micropillars with slightly high concentration near the heads (FIG. 3B). 500 nm silica particles were found mostly assembled on the top of the micropillars, but some of them also spread over the sidewall (FIG. 3C). When the silica particle size was increased to 1 μm, non-close packed silica particles were localized only on the top part of the micropillars (FIG. 3D).

To quantify the role of particles size, the particle settlement rate was calculated. The settling of unimodal suspension under normal gravity is given by:

$$v = ( \frac{2}{9} ) {a}^{2} ( {ρ}_{p} - ρ ) \frac{g}{η} \qquad ( 1 )$$

where a is the radius of particles, pₚ is the density of particles, p is the density of fluid, g is the gravity acceleration, and η is the viscosity of the fluid. Equation (1) shows that the velocity of particle settlement, v, increases in a parabolic manner with the radius of particles. The velocity ratio of 100 nm, 500 nm and 1 μm silica particles is 1:25:100. Therefore, given the same evaporation time, the larger particles will settle quicker to the bottom of the mold in comparison to smaller ones.

Shear Adhesion Strength of the Mechanically Interlocked Dual-Scale Micropillar Arrays

The adhesion strength between mechanically interlocked dual-scale micropillars was measured using a hanging scale (FIG. 4). Two identical micropillar arrays were put together against each other under a load (-300 g). A shear force parallel to substrates was applied while the scale was attached to one end of the substrate to measure the maximum force (FIG. 4B). The mechanical interlocking-based adhesion is dependent on the geometry of micropillars, including size, AR, SR, and surface roughness (i.e. the number and size of particles protrusion). An exemplary interlocked micropillar arrays is shown in FIG. 4C. Many micropillars were interdigitated with each other, while some were buckled. This may be due to the misalignment of the micropillars and low elastic modulus of PUA, causing the pillars to collapse during engagement. Interdigitation instead of indentation is likely to happen when α=1+SR is higher than √3. Therefore, all samples tested were expected to have interdigitation state of mechanical interlocking. A calculation with geometrical simplification is shown in FIG. 4D.

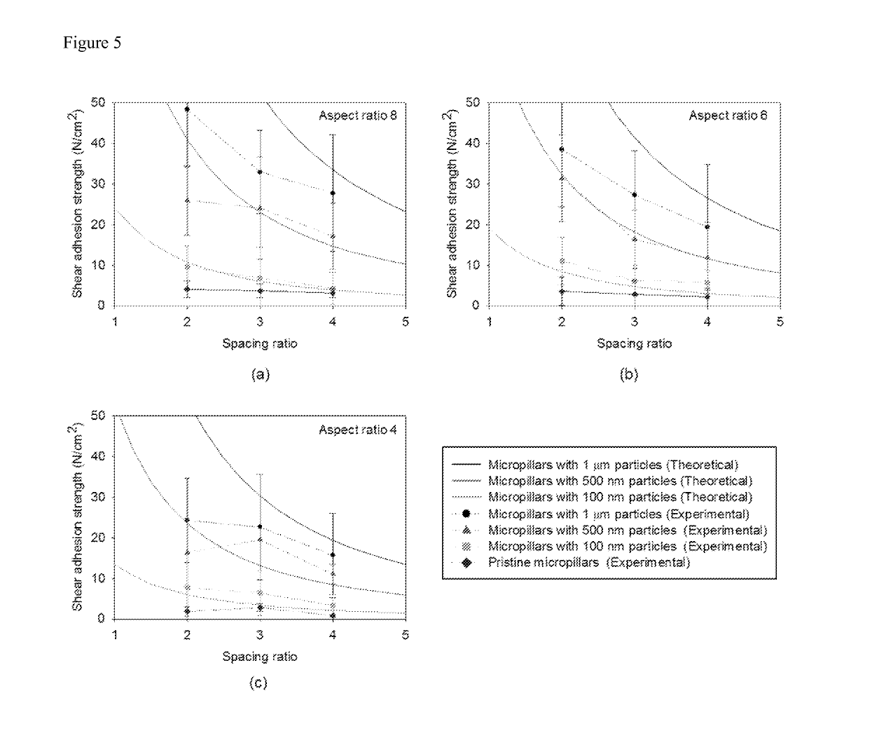

As shown in FIG. 5, the adhesion strength increased with increase particle size regardless of the AR of micropillars. The adhesion strength of micropillar array (diameter 5 μm, SR=2, and AR=8) was tripled, from 2.9 N/cm² (pristine pillars) to 8.82 N/cm² (pillars embedded with 100 nm particles), and could be further increased to 25.5 N/cm² from pillars embedded with 500 nm particles (FIG. 5A). Pillars embedded with 1 μm particles had the highest adhesion strength, 48.5 N/cm². This may be attributed to the fact that larger protrusions on the heads of the micropillars were formed using larger particles, thus increasing the chance for interlocking. FIG. 5A also showed a non-linear decay of adhesion strength with increasing the SR of the micropillar arrays, which could be explained by the reduced density of interlocked micropillars.

The same trend was observed in micropillars with lower ARs, 6 and 4, as shown in FIG. 5B and 5C, respectively. Again, particle-embedding contributed to significant increase of adhesion strength up to one order magnitude as compared to the pristine micropillars array. However, the slope of increasing adhesion strength decreased as the AR increased. It can be understood from the fact that the force to separate two interweaving pillars is smaller when the base length [L₁ in FIG. 4D] is shorter. When L₁ is long, the deflection of the pillar becomes large with pulling, which, in turn, may increase the required force to separate two interlocked pillars.

Comparison with the Theoretical Models

To better understand the dry adhesion mechanism of particle-embedded dual-scale micropillars, the theoretical adhesion strength is calculated based on Johnson-Kendall-Roberts (JKR) theory. Here, an equilibrium contact area is considered to be formed when the shear force is applied to the samples. In the JKR model, the adhesion force, F_{JKR}, is given by:

$${F}_{JKR} = \frac{3}{4} π Wd \qquad ( 2 )$$

Here, W is the work of adhesion, d is the effective diameter of contact. Giving the measured W of PUA ˜143.8 mN/m and the estimated d is 500 nm, the adhesion strengths of 2.34×10⁻¹, 1.32×10⁻¹, and 8.46×10⁻²N/cm² for micropillars with SRs of 2, 3 and 4, respectively. These values are about 1 to 2 orders of magnitude lower than the measured adhesion strength. Moreover, the model could not explain the increasing adhesion strength with the embedding of particles since the JKR model is mainly based on single contact point for each micropillar, regardless of the AR and particles embedding. Therefore, the roughness of the pillars could not be accommodated in the current system.

Alternatively, a mathematical model incorporating the side contact of cylindrical micropillars when they were brought in contact against counter micropillars was employed. The adhesion force based on side contact of micropillars, F_{sc}, is given by:

$${F}_{sc} = {( \frac{π {E}^{*} {W}^{3} {d}^{2}}{8 ( 1 - {υ}^{2} )} )}^{1 / 4} {( \frac{{L}_{C}}{2} )}^{3 / 4} \qquad ( 3 )$$

Here, E*=Eₘφ+Eₚ(1−φ) is the effective elastic modulus, where Eₘ and Eₚ are the elastic modulus of polymer matrix and particles, respectively, 0 is the fraction of particles in the pillar, v is the Poisson's ratio, and Lₑ is the side contact length of micropillars. In the exemplary system, some of these values are given as follows: Eₘ=19.8 MPa, Eₚ=69 GPa (silica particles) and φ≈0.1. For 5 μm diameter PUA micropillars with υ=0.4, L_{c}=40 μm (AR=8, by assuming the maximum contact length), Equation (3) yields the adhesion strength of F_{sc}=1.71 N/cm², 0.96 N/cm², and 0.62 N/cm², respectively, for the corresponding micropillars with SR=2, 3, and 4. These values were comparable to experimental measurements of pristine micropillars, 1.78, 0.74 and 0.6 N/cm², respectively. However, this model failed to explain the increased adhesion with enlarged heads of the micropillars from particles embedding. The logical components for increasing F_{sc} according to Equation (3) are the changes of work of adhesion and/or increasing contact length. However, since the same PUA materials were used and since the contact length won't be greater than the actual length of micropillar itself, then there is no way to increase the adhesion, theoretically. Therefore, this model is also invalid for the examplary system.

A simple mathematical model based on interlocking adhesion of solid cylinders in the interweaving state was introduced. In this model, the adhesion force is purely generated from mechanical bending force required to separate interweaving solid cylinders. There are several assumptions made in this model to simplify the calculation. First, the particles embedded on the heads of micropillars are considered to be a repetitive arm to lock the micropillars during shear force application (see FIG. 4D). In this case, the arm length corresponds to the density and sizes of particles on the head of micropillars. Second, the particles embedded in polymeric micropillars are assumed to behave as a composite, where the elastic modulus is derived from the uniform distribution of particles filler in polymer matrix. From the Castigliano's first theorem, the force to separate two interweaving solid cylinders is:

$$P = \frac{{δ}^{p} {E}^{*} I}{( \frac{{L}_{2}^{3}}{3} + \frac{π {L}_{2}^{2} R}{2} + {L}_{2}^{2} {L}_{1} + 2 {L}_{2} {R}^{2} + {R}^{2} {L}_{1} + \frac{π {R}^{3}}{4} )} \qquad ( 4 )$$

Here, P is the force required to separate interlocking cylinders, δ is the deflection of micropillar during force application, E* is the effective elastic modulus, I is the moment of inertia, L₁ is the micropillar height, L₂ is the arm length, and R is the bent radius. Using this model, the maximum adhesion strength in the exemplary system with variation of embedded-particles sizes was estimated. It was hypothesized that n-layer of protrusions as large as the particle radius, r, in micropillar heads act as sequential interweaving states of interlocking adhesion with the total arm length, L₂=nr. Although the apparent interlocking micropillars were shown in the interdigitated state (FIG. 4C), the actual contact produced an interweaving state from particle protrusions. The calculation showed that this model matched well with the adhesion behavior in the exemplary system with 20% possible interdigitation of the total micropillars population. For example, in micropillars with AR=6 and SR=3, with the arrangement of particles shown in FIG. 2, the number of particle layer is approximately 10, 5 and 3 μm from the tips for 100 nm, 500 nm and 1 μm particles, respectively, giving the respective number of particle layer n as 100, 20 and 6. Taking the 20% of theoretical values calculated in Equation (4), adhesion strength of 4.76, 18.1, and 41.4 N/cm² was obtained for micropillars embedded with particles of 100 nm, 500 nm, and 1 μm, respectively. These values were close to experimental ones, that is 6.1, 16.4, and 27.3 N/cm², respectively. The difference between experiments and theoretical values could be attributed to the presence of defects in micropillar arrays and non-uniform pre-loading during contact process, thus, substantially lowered the percentage of the interlocked pillars.

In addition, the shear adhesion strength with different AR and SR as a function of particle size was investigated. As seen from FIG. 5, in most cases of variable particle sizes and SRs, the model matched well with the experimental measurements. The theoretical values shown in FIG. 5 were 20% of the values calculated from Equation (4). It should be noted that for all pillars with variable ARs and small SR of 2, the model over-estimated the adhesion strength. Nevertheless, even at low SR, the adhesion was enhanced by embedding particles in the micropillars.

Reversibility of Adhesion

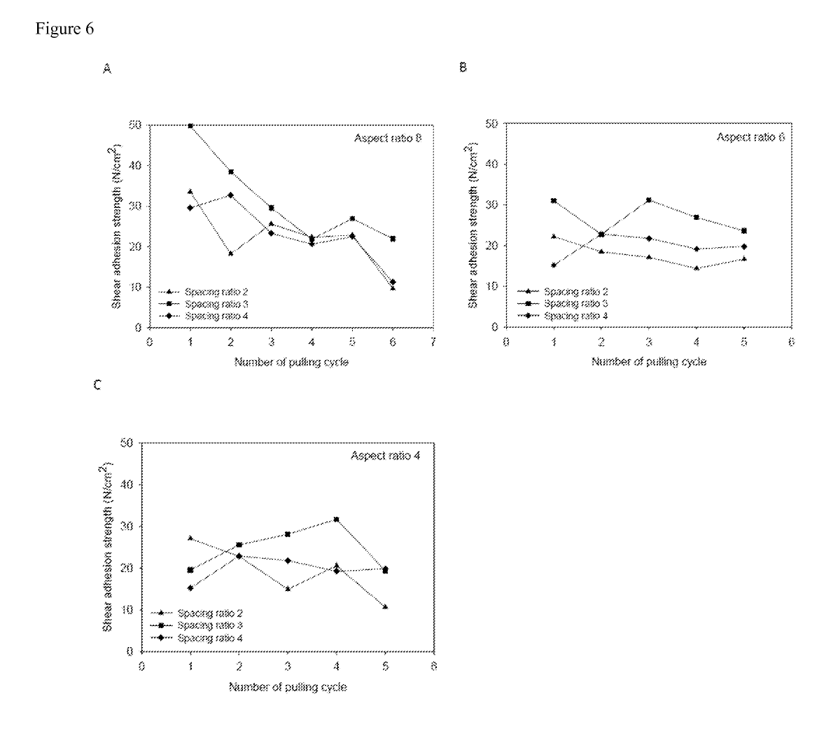

To evaluate the reversibility of the silica embedded micropillar adhesion, pull-off tests were performed 5-6 times (FIG. 6). It was observed that up to 5 times pulling cycle, the shear adhesion strength remained about 75% of the initial shear adhesion strength. After 6 times pulling cycle, a significant reduction in shear adhesion due to damaged interlocked pillars was observed. This reduction is not significantly observed when the aspect ratio is low (aspect ratio 6 or 4). Choice of materials and pillar geometry may increase the reversibility, allowing the adhesion system to be reused greater than 6 times.

The above results show an enhanced shear adhesion strength between mechanically interlocked elastomeric micropillar arrays with embedded silica particle on the heads of the micropillars by more than an order of magnitude as compared to those without particles (e.g., 48.5 N/cm² vs. 4.1 N/cm²). The calculation suggested that interlocking adhesion model of solid cylinders with interweaving state matched well with the experimental results.

Those skilled in the art will appreciate that numerous changes and modifications can be made to the preferred embodiments of the disclosed systems, materials, and methods, and that such changes and modifications can be made without departing from the spirit of the disclosed systems, materials, and methods. It is, therefore, intended that the appended claims cover all such equivalent variations as fall within the true spirit and scope of the systems, materials, and methods.

The disclosures of each patent, patent application, and publication cited or described in this document are hereby incorporated herein by reference, in its entirety.

### Embodiments

The following list of embodiments is intended to complement, rather than displace or supersede, the previous descriptions.

Embodiment 1. An adhesion system comprising: a first substrate at least a portion of the surface of which having an array of micropillars, at least a distal portion of said micropillars having a plurality of particles embedded therein; and a second substrate at least a portion of the surface of which having an array of micropillars, at least a distal portion of said micropillars having a plurality of particles embedded therein.

Embodiment 2. The adhesion system according to Embodiment 1, wherein said plurality of particles are embedded substantially on a distal end of the micropillars.

Embodiment 3. The adhesion system according to Embodiment 1, wherein said plurality of particles are embedded throughout said micropillars.

Embodiment 4. The adhesion system according to any one of the preceding Embodiments, wherein said micropillars are comprised of an elastomer.

Embodiment 5. The adhesion system according to Embodiment 4, wherein said elastomer is a polyurethane acrylate (PUA).

Embodiment 6. The adhesion system according to any one of the preceding Embodiments, wherein said plurality of particles comprises a single particle type.

Embodiment 7. The adhesion system according to any one of the preceding Embodiments, wherein said plurality of particles comprises silica.

Embodiment 8. The adhesion system according to any one of the preceding Embodiments, wherein the plurality of particles have a diameter of about 20 nm to about 10 μm.

Embodiment 9. The adhesion system according to any one of the preceding Embodiments, said micropillars having a diameter of about 100 nm to about 50 μm.

Embodiment 10. The adhesion system according to any one of the preceding Embodiments, wherein said array of micropillars is selected to conform to a geometric pattern.

Embodiment 11. The adhesion system according to any one of the preceding Embodiments, said array of micropillars having a height of about 1 μm to about 500 μm.

Embodiment 12. The adhesion system according to any one of the preceding Embodiments, wherein the plurality of particles embedded on a distal end of the micropillars have a thickness from about 1% to about 50% of the height of the micropillars.

Embodiment 13. The adhesion system according to any one of the preceding Embodiments, said array of micropillars having an aspect ratio of about 2 to about 10.

Embodiment 14. The adhesion system according to any one of the preceding Embodiments, said array of micropillars having a spacing ratio of about 2 to about 6.

Embodiment 15. The adhesion system according to any one of the preceding Embodiments, wherein said substrates are arranged such that the array of micropillars from said first substrate are capable of interacting with the array of micropillars from said second substrate.

Embodiment 16. The adhesion system according to Embodiment 15, wherein said array of micropillars from the first substrate and said array of micropillars from the second substrate are capable of interlocking.

Embodiment 17. The adhesion system according to Embodiment 16, wherein said interlocking comprises interdigitation, interweaving, indentation, or any combination thereof.

Embodiment 18. The adhesion system according to any one of the preceding Embodiments, wherein a strength of interaction between the array of micropillars from the first substrate and the array of micropillars from the second substrate is greater than an interaction between pristine micropillars.

Embodiment 19. The adhesion system according to Embodiment 18, wherein the strength of interaction is at least 4 to 5 times greater than an interaction between pristine micropillars.

Embodiment 20. The adhesion system according to any one of the preceding Embodiments, wherein said interaction between the micropillars of the first substrate and the micropillars of the second substrate is reversible.

Embodiment 21. The adhesion system according to any one of the preceding Embodiments, wherein said system is reusable.

Embodiment 22. The adhesion system according to any one of the preceding Embodiments, optionally comprising one or more additional substrates at least a portion of the surface of which having an array of micropillars, at least a portion of said micropillars having a plurality of particles embedded therein.

Embodiment 23. An adhesive material comprising: a substrate at least a portion of the surface of which having an array of micropillars, at least a portion of said micropillars having a plurality of particles embedded therein.

Embodiment 24. The adhesive material according to Embodiment 23, wherein said plurality of particles are embedded substantially on a distal end of the micropillars.

Embodiment 25. The adhesive material according to Embodiment 23, wherein said plurality of particles are embedded randomly on said micropillars.

Embodiment 26. The adhesive material according to any one of Embodiments 23 to 25, wherein said micropillars are composed of an elastomer.

Embodiment 27. The adhesive material according to Embodiment 26, wherein said elastomer is polyurethane acrylate (PUA).

Embodiment 28. The adhesive material according to any one of Embodiments 23 to 27, wherein said plurality of particles comprises a single particle type.

Embodiment 29. The adhesive material according to any one of Embodiments 23 to 28, wherein said plurality of particles comprises silica.

Embodiment 30. The adhesive material according to any one of Embodiments 23 to 29, wherein the plurality of particles have a diameter of about 20 nm to about 10 μm.

Embodiment 31. The adhesive material according to any one of Embodiments 23 to 30, said micropillars having a diameter of about 100 nm to about 50 μm.

Embodiment 32. The adhesive material according to any one of Embodiments 23 to 31, wherein said array of micropillars is selected to conform to a geometric pattern.

Embodiment 33. The adhesive material according to any one of Embodiments 23 to 32, said array of micropillars having a height of about 1 μm to about 500 μm.

Embodiment 34. The adhesive material according to any one of Embodiments 23 to 34, said array of micropillars having an aspect ratio of about 2 to about 10.

Embodiment 35. The adhesive material according to any one of Embodiments 23 to 34, said array of micropillars having a spacing ratio of about 2 to about 6.

Embodiment 36. A method of forming adhesive materials according to any one of Embodiments 23 to 35 comprising: drop-casting a particle suspension over a mold, wherein the particle suspension contains a solvent and a plurality of particles; removing excess solvent from the mold; removing excess particles; filling the mold with one or more elastomers; polymerizing the elastomers; and removing the adhesive material from the mold.

Embodiment 37. The method according to Embodiment 36, wherein the mold comprises PDMS.

Embodiment 38. The method according to any one of Embodiments 36 to 37, wherein the plurality of particles comprise silica.

Embodiment 39. The method according to any one of Embodiments 36 to 38, wherein the excess solvent is removed by blading.

Embodiment 40. The method according to any one of Embodiments 36 to 39, wherein the elastomer is UV-curable PUA.

Embodiment 41. The method according to any one of Embodiments 36 to 40, wherein the elastomers are polymerized by photopolymerization with UV light.

1. An adhesion system comprising:
a first substrate at least a portion of the surface of which having an array of micropillars, at least a distal portion of said micropillars having a plurality of particles embedded therein; and
a second substrate at least a portion of the surface of which having an array of micropillars, at least a distal portion of said micropillars having a plurality of particles embedded therein.

2. The adhesion system of claim 1, wherein said plurality of particles are embedded substantially on a distal end of the micropillars.

3. The adhesion system of claim 1, wherein said plurality of particles are embedded throughout said micropillars.

4. The adhesion system of claim 1, wherein said micropillars are comprised of an elastomer.

5. The adhesion system of claim 4, wherein said elastomer is a polyurethane acrylate (PUA).

6. The adhesion system of claim 1, wherein said plurality of particles comprises a single particle type.

7. The adhesion system of claim 1, wherein said plurality of particles comprises silica.

8. The adhesion system of claim 1, wherein the plurality of particles have a diameter of about 20 nm to about 10 μm.

9. The adhesion system of claim 1, said micropillars having a diameter of about 100 nm to about 50 μm.

10. The adhesion system of claim 1, wherein said array of micropillars is selected to conform to a geometric pattern.

11. The adhesion system of claim 1, said array of micropillars having a height of about 1 μm to about 500 μm.

12. The adhesion system of claim 1, wherein the plurality of particles embedded on a distal end of the micropillars have a thickness from about 1% to about 50% of the height of the micropillars.

13. The adhesion system of claim 1, said array of micropillars having an aspect ratio of about 2 to about 10.

14. The adhesion system of claim 1, said array of micropillars having a spacing ratio of about 2 to about 6.

15. The adhesion system of claim 1, wherein said substrates are arranged such that the array of micropillars from said first substrate are capable of interacting with the array of micropillars from said second substrate.

16. The adhesion system of claim 15, wherein said array of micropillars from the first substrate and said array of micropillars from the second substrate are capable of interlocking.

17. The adhesion system of claim 16, wherein said interlocking comprises interdigitation, interweaving, indentation, or any combination thereof.

18. The adhesion system of claim 1, wherein a strength of interaction between the array of micropillars from the first substrate and the array of micropillars from the second substrate is greater than an interaction between pristine micropillars.

19. The adhesion system of claim 18, wherein the strength of interaction is at least 4 to 5 times greater than an interaction between pristine micropillars.

20. The adhesion system of claim 1, wherein said interaction between the micropillars of the first substrate and the micropillars of the second substrate is reversible.

21. The adhesion system of claim 1, wherein said system is reusable.

22. The adhesion system of claim 1, optionally comprising one or more additional substrates at least a portion of the surface of which having an array of micropillars, at least a portion of said micropillars having a plurality of particles embedded therein.

23. An adhesive material comprising:
a substrate at least a portion of the surface of which having an array of micropillars, at least a portion of said micropillars having a plurality of particles embedded therein.

24. The adhesive material of claim 23, wherein said plurality of particles are embedded substantially on a distal end of the micropillars.

25. The adhesive material of claim 23, wherein said plurality of particles are embedded randomly on said micropillars.

26. The adhesive material of claim 23, wherein said micropillars are composed of an elastomer.

27. The adhesive material of claim 26, wherein said elastomer is polyurethane acrylate (PUA).

28. The adhesive material of claim 23, wherein said plurality of particles comprises a single particle type.

29. The adhesive material of claim 23, wherein said plurality of particles comprises silica.

30. The adhesive material of claim 23, wherein the plurality of particles have a diameter of about 20 nm to about 10 μm.

31. The adhesive material of claim 23, said micropillars having a diameter of about 100 nm to about 50 μm.

32. The adhesive material of claim 23, wherein said array of micropillars is selected to conform to a geometric pattern.

33. The adhesive material of claim 23, said array of micropillars having a height of about 1 μm to about 500 μm.

34. The adhesive material of claim 23, said array of micropillars having an aspect ratio of about 2 to about 10.

35. The adhesive material of claim 23, said array of micropillars having a spacing ratio of about 2 to about 6.

36. A method of forming the adhesive material of claim 23 comprising:
drop-casting a particle suspension over a mold, wherein the particle suspension contains a solvent and a plurality of particles;
removing excess solvent from the mold;
removing excess particles;
filling the mold with one or more elastomers;
polymerizing the elastomers;
and removing the adhesive material from the mold.

37. The method of claim 36, wherein the mold comprises PDMS.

38. The method of claim 36, wherein the plurality of particles comprise silica.

39. The method of claim 36, wherein the excess solvent is removed by blading.

40. The method of claim 36, wherein the elastomer is UV-curable PUA.

41. The method of claim 36, wherein the elastomers are polymerized by photopolymerization with UV light.
